(19) United States
(12) Patent Application Publication
(10) Pub. No.: US 2019/0191662 A1
(43) Pub. Date: Jun. 27, 2019

(54) ANIMAL TOILET

(71) Applicant: SHARP KABUSHIKI KAISHA, Sakai City (JP)

(72) Inventors: KAZUO TAKADA, Sakai City (JP); AYAKO SEKINE, Sakai City (JP)

(21) Appl. No.: 16/222,930

(22) Filed: Dec. 17, 2018

(30) Foreign Application Priority Data
Dec. 26, 2017 (JP) 2017-250221

(51) Int. Cl. A01K 1/01; G01G 19/52

(52) U.S. Cl. CPC A01K 1/0107; G01G 19/52; A01K 1/0103

(57) ABSTRACT

To provide a pet toilet capable of weighing an excretion and preventing an excretion from leaking out even with an excretion receiving container detached, a pet toilet (1) includes a weight scale (40) including (i) a table (42) configured to be pressed by an excretion receiving container (16) and (ii) a weight sensor (41) configured to output an electric signal corresponding to a pressing force from the table (42), the table (42) having a depressed portion (46) that coincides with a mesh (22) above across the excretion receiving container (16).

This Nonprovisional application claims priority under U.S.C. § 119 on Patent Application No. 2017-250221 filed in Japan on Dec. 26, 2017, the entire contents of which are hereby incorporated by reference.

### TECHNICAL FIELD

The present invention relates to an animal toilet.

### BACKGROUND ART

Toilets for pet animals are in general use. Patent Literature 1 discloses an animal toilet including (i) a support table that allows a pet animal to stand thereon, (ii) an excretion tray configured to be slid in the main container to be positioned under the support table, and (iii) a weight scale provided under the excretion tray inside the main container. The weight scale is inserted in the main container through a through hole in the bottom of the main container, and supports the excretion tray inside the main container in such a manner as to lift the excretion tray from below.

The animal toilet is configured such that the excretion tray receives urine discharged by a pet on the support table and that the weight scale measures how much the excretion tray is heavier due to the received urine in order to weigh the urine discharged by the pet. This helps monitor the health condition of the pet.

### CITATION LIST

### Patent Literature

[Patent Literature 1]

Japanese Patent Application Publication, Tokukai, No. 2017-153400

### SUMMARY OF INVENTION

### Technical Problem

The excretion tray is detachable from the main container in order for the pet owner to easily remove an excretion received by the excretion tray and clean the excretion tray. The owner may, for instance, forget to insert the detached excretion tray in the main container, so that the excretion tray is kept detached from the main container. In a case where the pet uses the animal toilet with the excretion tray detached therefrom, the animal toilet cannot weigh the excretion, and/or the excretion leaks through the through hole in the bottom of the main container out of the main container, dirtying the area surrounding the animal toilet.

It is an object of an aspect of the present invention to provide an animal toilet capable of weighing an excretion and preventing an excretion from leaking out even with an excretion receiving container detached.

### Solution to Problem

In order to attain the above object, an animal toilet in accordance with an aspect of the present invention includes: a support table having a bottom surface having an opening through which an excretion of an animal passes; an excretion receiving container, the excretion receiving container being detachable and configured to (i) face the opening when attached and (ii) receive the excretion having passed through the opening; and a weight scale present opposite to the support table across the excretion receiving container as attached, the weight scale being configured to weigh the excretion received by the excretion receiving container, the weight scale including (i) a table configured to be pressed by the excretion receiving container as attached and (ii) a weight sensor configured to output an electric signal indicative of a value of a measured weight which value corresponds to a pressing force from the table, the table included in the weight scale having at least one depressed portion that coincides with the opening across the excretion receiving container as attached.

### Advantageous Effects of Invention

An aspect of the present invention produces an effect of weighing an excretion and preventing an excretion from leaking out even with an excretion receiving container detached.

### BRIEF DESCRIPTION OF DRAWINGS

FIG. 1 is an exploded perspective view of a pet toilet in accordance with Embodiment 1, illustrating the configuration of the pet toilet.

(a) of FIG. 2 is a plan view of the pet toilet in accordance with Embodiment 1, illustrating the overall configuration of the pet toilet. (b) of FIG. 2 is a left side view of the pet toilet illustrated in (a) of FIG. 2, illustrating the overall configuration of the pet toilet. (c) of FIG. 2 is a right side view of the pet toilet illustrated in (a) of FIG. 2, illustrating the overall configuration of the pet toilet. (d) of FIG. 2 is a front side view of the pet toilet illustrated in (a) of FIG. 2, illustrating the overall configuration of the pet toilet.

FIG. 3 is a cross-sectional view of the pet toilet in accordance with Embodiment 1.

(a) of FIG. 4 is a perspective view of a weight scale included in the pet toilet in accordance with Embodiment 1, illustrating the configuration of the weight scale on the side of its upper surface. (b) of FIG. 4 is a perspective view of the weight scale illustrated in (a) of FIG. 4, illustrating the configuration of the weight scale on the side of its lower surface.

FIG. 5 is a block diagram illustrating the configuration of a control device included in the pet toilet in accordance with Embodiment 1.

FIG. 6 is a cross-sectional view of a pet toilet in accordance with a comparative example, illustrating the configuration of the pet toilet.

(a) of FIG. 7 is a plan view of a pet toilet in accordance with Embodiment 2, illustrating the overall configuration of the pet toilet. (b) of FIG. 7 is a left side view of the pet toilet illustrated in (a) of FIG. 7, illustrating the overall configuration of the pet toilet. (c) of FIG. 7 is a right side view of the pet toilet illustrated in (a) of FIG. 7, illustrating the overall configuration of the pet toilet. (d) of FIG. 7 is a front side view of the pet toilet illustrated in (a) of FIG. 7, illustrating the overall configuration of the pet toilet.

FIG. 8 is a cross-sectional view of the pet toilet in accordance with Embodiment 2, illustrating the configuration of the pet toilet.

FIG. 9 is a perspective view of a weight scale included in a pet toilet in accordance with Embodiment 3.

FIG. 10 is a perspective view of a weight scale included in a pet toilet in accordance with Embodiment 4.

FIG. 11 is a perspective view of a weight scale included in a pet toilet in accordance with Embodiment 5.

(a) of FIG. 12 is a perspective view of a weight scale included in a pet toilet in accordance with Embodiment 6. (b) of FIG. 12 is a cross-sectional view of the weight scale illustrated in (a) of FIG. 12.

(a) of FIG. 13 is a perspective view of a weight scale included in a pet toilet in accordance with Embodiment 7. (b) of FIG. 13 is a cross-sectional view of the weight scale illustrated in (a) of FIG. 13.

(a) of FIG. 14 is a perspective view of a weight scale included in a pet toilet in accordance with Embodiment 8. (b) of FIG. 14 is a cross-sectional view of the weight scale illustrated in (a) of FIG. 14.

(a) of FIG. 15 is a perspective view of a weight scale included in a pet toilet in accordance with Embodiment 9. (b) of FIG. 15 is a cross-sectional view of the weight scale illustrated in (a) of FIGS. 15.

### DESCRIPTION OF EMBODIMENTS

### Embodiment 1

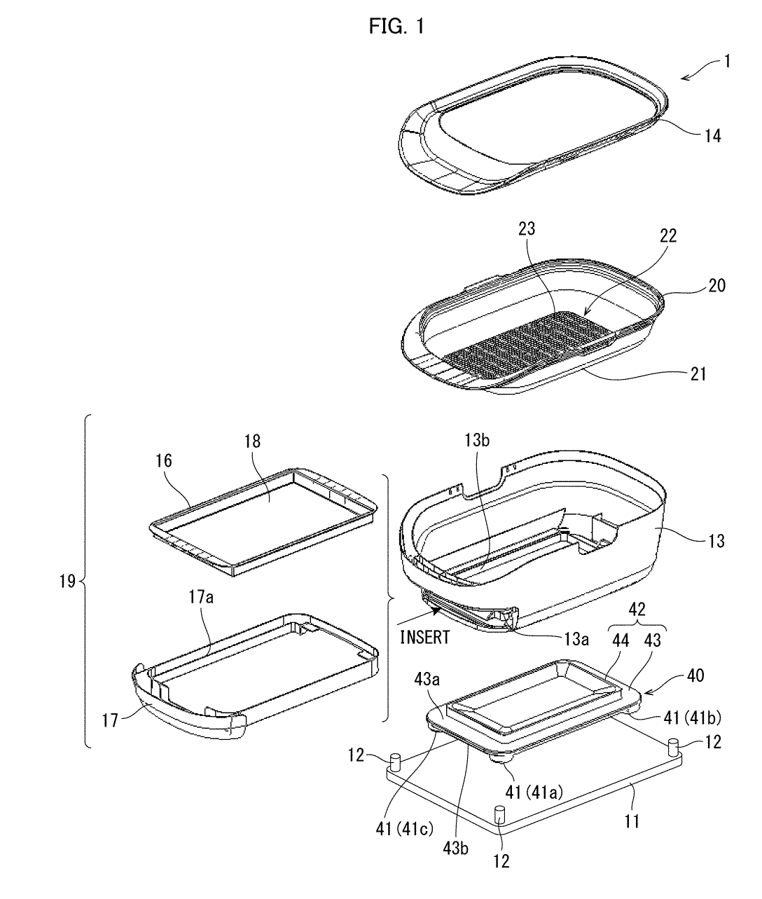

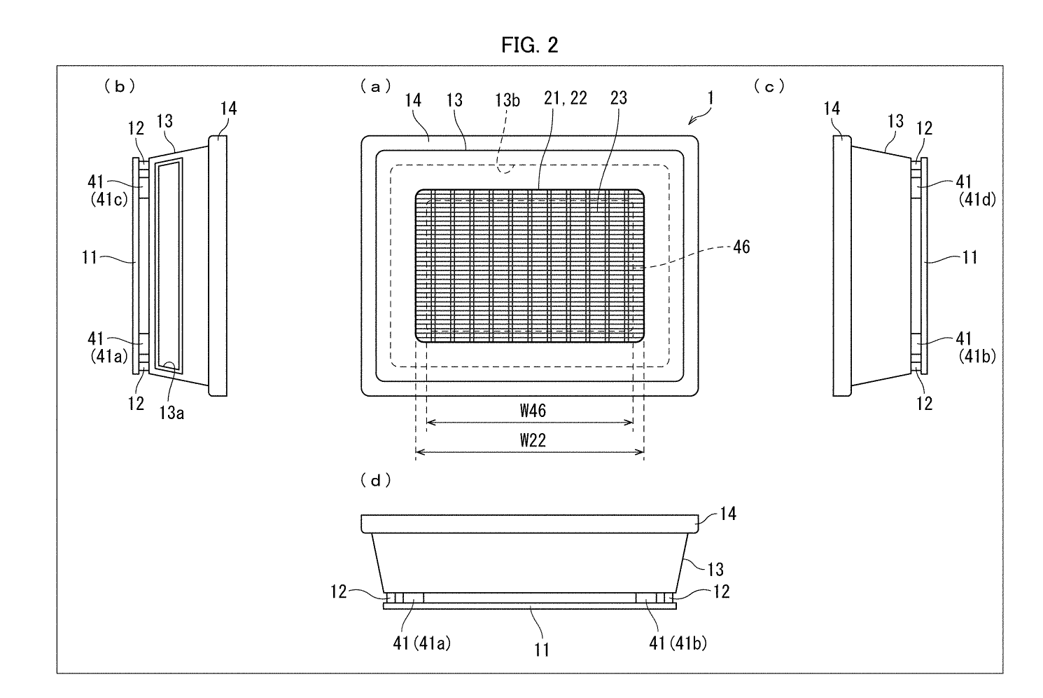

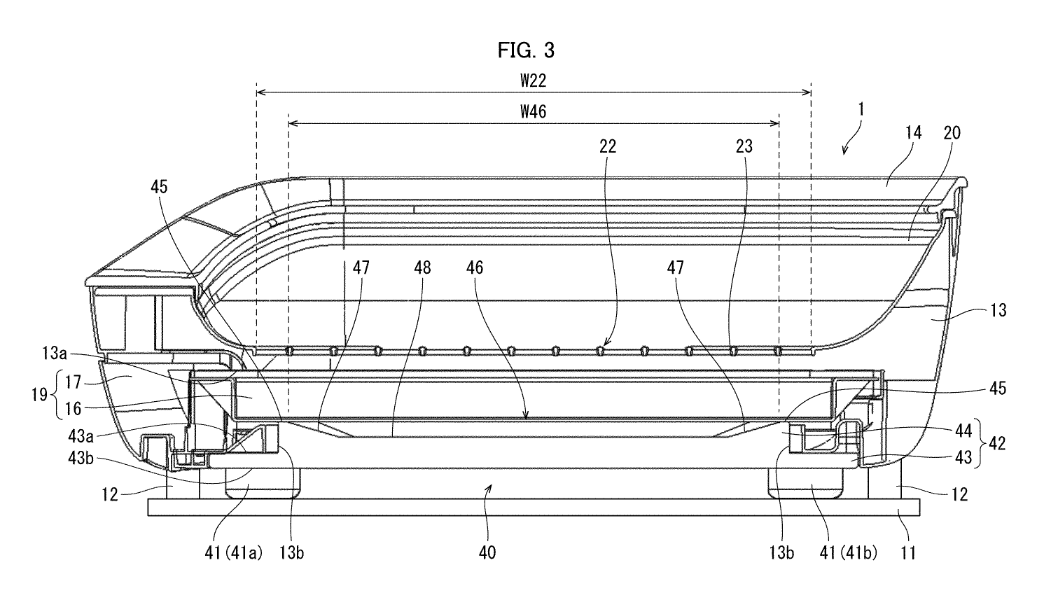

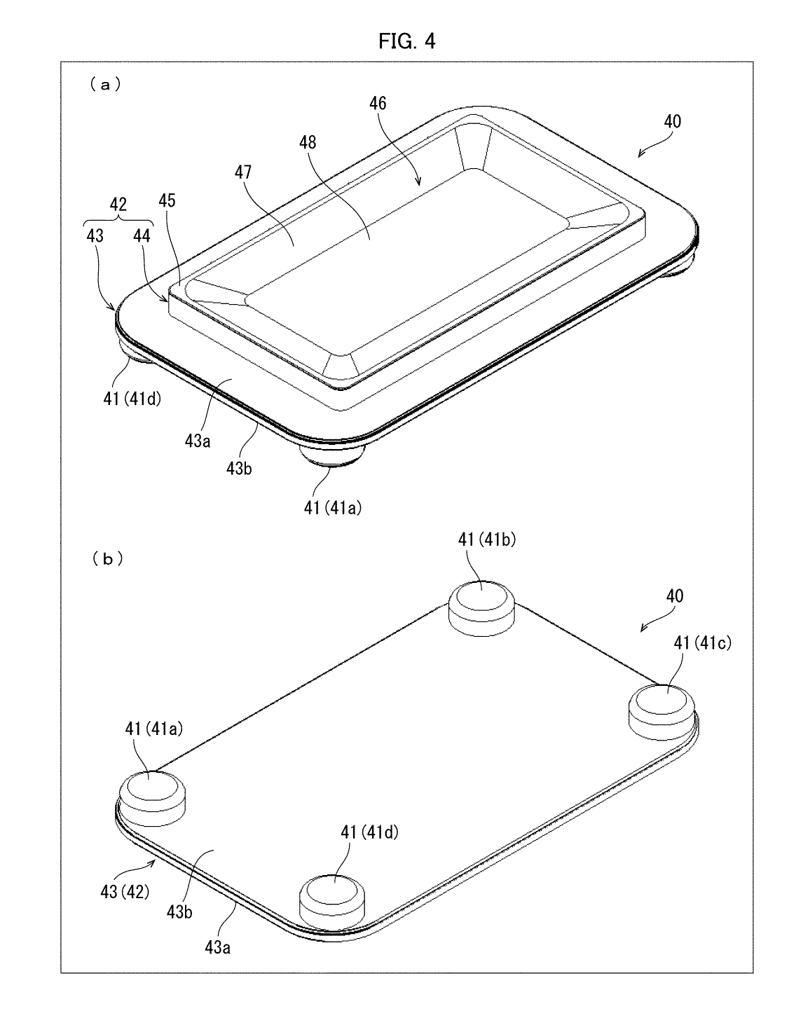

FIG. 1 is an exploded perspective view of a pet toilet 1 in accordance with Embodiment 1, illustrating the configuration of the pet toilet 1. (a) of FIG. 2 is a plan view of the pet toilet 1, illustrating the overall configuration of the pet toilet 1. (b) of FIG. 2 is a left side view of the pet toilet 1, illustrating the overall configuration of the pet toilet 1. (c) of FIG. 2 is a right side view of the pet toilet 1, illustrating the overall configuration of the pet toilet 1. (d) of FIG. 2 is a front view of the pet toilet 1, illustrating the overall configuration of the pet toilet 1. FIG. 3 is a cross-sectional view of the pet toilet 1.

The pet toilet 1 in accordance with the present embodiment is an example animal toilet. The pet toilet 1 is used by a pet such as a cat or a dog (that is, an animal kept domestically) when the pet urinates. The pet is not limited to a cat or a dog, and may be another animal. The present embodiment described here is a pet toilet 1 having the function of measuring, for example, the amount of discharged urine and the number of times of urination for the pet's healthcare.

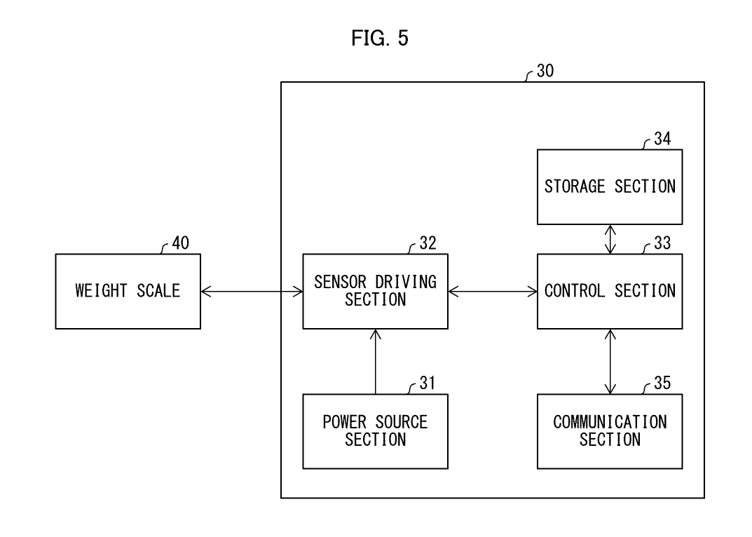

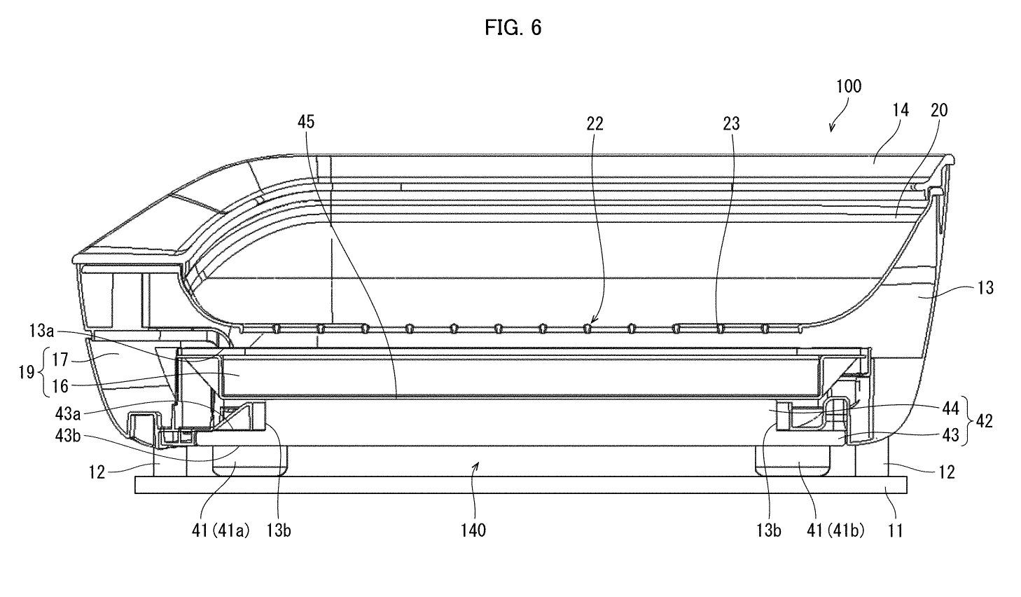

As illustrated in FIGS. 1 to 3, the pet toilet 1 includes a support plate 11, vertical poles 12, a main container 13, a support table frame 14, an excretion tray 19, a support table 20, and a weight scale 40. The pet toilet 1 further includes a control device 30 (see FIG. 5). The pet toilet 1 may further include a cover (not shown) that covers the support table 20.

The main container 13 is supported by four vertical poles 12 each standing at one of the four corners of the support plate 11. The main container 13 is hollow, and has (i) an upper surface (that is, the surface on the side of which the support table 20 is inserted into the main container 13 as described later) with an opening and (ii) a lower surface (that is, the surface on the side of which the weight scale 40 is inserted into the main container 13 as described later) with an opening. As illustrated in FIGS. 1 to 3, the main container 13 is configured to contain (i) a support table 20 on which a pet (animal) stands (that is, a support table configured to support an animal) and (ii) an excretion tray 19 under the support table 20 which excretion tray 19 is capable of being slid into the main container 13. The support table 20 may be filled with a filler such as water-repellent gravel, sand, or glass beads. The support table 20 may itself be water-repellent to (i) prevent urine from remaining thereon and (ii) allow urine to easily run thereon. The pet toilet 1 may alternatively further include a member other than the support table 20 which member is supported by the support table 20 and be configured such that an animal stands on that member.

The support table 20 is inserted into the main container 13 through the upper opening of the main container 13 to be mounted in the main container 13. The support table frame 14 is mounted on the edge of the support table 20.

The support table 20 is a table on which an animal stands for excretion. The support table 20 includes a bottom part 21 having a mesh (opening) 22 including a plurality of slits 23. An excretion (in this example, urine) that an animal has discharged from above the mesh 22 passes through the mesh 22 to fall onto the excretion tray 19 placed to face the bottom part 21 of the support table 20. The mesh 22 in this example allows a liquid to pass therethrough, but does not allow, for example, feces or an object (for example, a toy) that the animal has brought in its mouth.

The support table 20 may have, instead of the mesh 22, an opening with a different shape which opening allows an excretion to pass therethrough. The support table 20 in accordance with the present embodiment is shaped like a recessed container. The shape of the support table 20 is, however, not limited to such a shape. The pet toilet 1 may alternatively further include a member other than the support table 20 which member is supported by the support table 20 and be configured such that an animal stands on that member. The bottom part 21 in accordance with the present embodiment is flat, and has a mesh 22 across the entire surface thereof. The mesh 22 may be provided in only a portion of the bottom part 21.

As illustrated in FIG. 1, the excretion tray 19 includes an excretion receiving container 16 and a slidable frame 17. The excretion tray 19 is capable of being inserted in the main container 13. The slidable frame 17, on which the dish-shaped excretion receiving container 16 is placeable, is a rectangular frame having an opening 17a at its center. Fitting the excretion receiving container 16 into the opening 17a allows the excretion receiving container 16 to be mounted on the slidable frame 17. The excretion receiving container 16 is combined with an absorbing sheet 18 as a retainer laid on the excretion receiving container 16. The absorbing sheet 18 is preferably, for example, a retainer containing a water absorbent resin and having high water absorbency. The retainer is, however, not limited to such a retainer, and may be any retainer capable of absorbing liquid such as sponge or paper.

As illustrated in FIGS. 1 and 3, the excretion tray 19 is slid into the main container 13 through a side opening 13a in a side portion of the main container 13. This allows the excretion tray 19 to be positioned under the bottom part 21 of the support table 20 mounted on the main container 13, in other words, allows the excretion tray 19 to face the bottom part 21 of the support table 20 mounted on the main container 13. Sliding the excretion tray 19 in the main container 13 in such a manner as to pull out the excretion tray 19 through the side opening 13a allows the excretion tray 19 to be separated from the main container 13.

The bottom part of the main container 13 has a weight scale through hole 13b. With the weight scale through hole 13b, the main container 13 is open below the excretion tray 19 inserted in the main container 13.

(a) of FIG. 4 is a perspective view of the weight scale 40, illustrating the configuration of the weight scale 40 on the side of its upper surface. (b) of FIG. 4 is a perspective view of the weight scale 40, illustrating the configuration of the weight scale 40 on the side of its lower surface. As illustrated in FIG. 4, the weight scale 40 includes one or more weight sensors 41 and a table 42. The table 42 includes (i) a plate-shaped section (plate-shaped member) 43 as a base and (ii) a protruding section 44 protruding from the plate-shaped section 43. The plate-shaped section has two principal surfaces, one of which is a first surface 43a (upper surface) present on the side of the excretion receiving container 16 inserted in the main container 13 and the other of which is a second surface 43b (lower surface) present opposite to the first surface and on the side of the support plate 11.

The weight sensors 41 are attached to the second surface 43b of the plate-shaped section 43 in such a manner that the head of each weight sensor 41 is in contact with the second surface 43b. The present embodiment is configured such that four weight sensors 41 (namely, weight sensors 41a, 41b, 41c, and 41d) are each attached to one of the four corners of the second surface 43b of the plate-shaped section 43. The weight sensors 41 are each configured to, when pressed by the table 42, convert the pressing force into an electric signal and output the electric signal.

The weight sensors 41 are each, for example, a load cell. In a case where the weight sensors 41 are each a load cell, the load cell is any of various load cells such as a spring-type load cell, a piezoelectric load cell, a magnetostrictive load cell, a capacitive load cell, a gyroscopic load cell, and a strain gauge load cell. The weight sensors 41 may each be other than a load cell, for example, an electromagnetic equilibrium sensor or a tuning fork sensor.

The weight sensors 41 may each be integrated with the table 42. In a case where, for instance, the weight sensors 41 are each a load cell of a strain sensor type, the weight sensors 41 are each configured such that an internal component of the weight sensor 41 is deformed by a weight, that the strain sensor converts the amount of the deformation of the internal component into an electric signal, and that the weight sensor 41 outputs the electric signal. This allows the weight scale 40 to measure a weight.

The weight scale 40 may include only one weight sensor 41 on the second surface 43b of the plate-shaped section 43. However, the weight scale 40 preferably includes two or more (for example, four) weight sensors 41 as illustrated in, for example, FIG. 4. Such two or more weight sensors 41 make it possible to accurately weigh an excretion even in a case where the excretion has fallen onto random positions on the plate-shaped section 43.

The protruding section 44 has a substantially rectangular shape in a plan view. The protruding section 44 protrudes from the first surface 43a of the plate-shaped section 43. The protruding section 44 has a top surface 45 having a depressed portion 46. The depressed portion 46 of the protruding section 44 has a side surface 47 along the four sides which side surface 47 is inclined such that the depressed portion 46 is narrower at the bottom surface 48 and wider at the top surface 45. The bottom surface 48 of the depressed portion 46 is, for example, a flat surface. The protruding section 44 is, in other words, shaped like a dish including a bottom surface 48 and a wall surrounding the bottom surface 48.

As illustrated in FIGS. 2 and 3, the depressed portion coincides with the mesh 22 across the excretion receiving container 16 inserted in the main container 13. The depressed portion 46, in other words, faces the mesh 22 with the excretion receiving container 16 removed from the main container 13.

As illustrated in FIG. 3, when the main container 13 is placed on the vertical poles 12, the protruding section 44 of the table 42 enters the main container 13 through the weight scale through hole 13b of the main container 13.

Then, when the excretion tray 19 has been slid into the main container 13 through the side opening 13a, the back surface of the excretion receiving container 16 (that is, the surface opposite to the surface on which the absorbing sheet 18 is present) comes into contact with the top surface 45 of the protruding section 44, so that the excretion receiving container 16 is placed on the table 42. In other words, sliding the excretion tray 19 into the main container 13 through the side opening 13a causes the back surface of the excretion receiving container 16 to slide along the top surface 45 of the protruding section 44 while in contact with the top surface 45.

When the excretion tray 19 has been fully inserted into the main container 13, the excretion receiving container 16, which used to be supported by the slidable frame 17, has been lifted on the table 42, so that the excretion receiving container 16 is supported by the table 42 and the weight sensors 41.

When the excretion receiving container 16 has been inserted in the main container 13, the excretion receiving container 16 presses the table 42, which in turn presses the weight sensors 41. When the excretion receiving container 16 has received an excretion, a pressing force corresponding to the weight of the excretion is transmitted from the excretion receiving container 16 to the table 42 and then to the weight sensors 41. This configuration allows the weight scale 40 to weigh urine absorbed by the absorbing sheet 18 laid on the excretion receiving container 16.

A cat as a pet, for example, discharges urine two to three times a day, in an amount of 20 g to 30 g a day per kilogram of the body weight. A mature cat, which typically has a body weight of 3 kg to 5 kg, discharges urine onto the absorbing sheet 18 in an amount of normally 60 g to 150 g per day. When a mature cat is, for example, sick, it tends to discharge urine fewer times and/or in a smaller amount. In combination with this knowledge, the pet owner, for example, can learn the health condition of the pet such as a cat by using the pet toilet 1 of the present embodiment to measure how many times and/or how much (weight) the pet urinates.

The table 42 does not come into contact with the main container 13, and is thus not pressed by the main container 13.

FIG. 5 is a block diagram illustrating the configuration of a control device 30 included in the pet toilet 1 in accordance with Embodiment 1. The control device 30 carries out operations such as controlling how the weight scale 40 is driven and receiving electric signals from the weight sensors 41.

As illustrated in FIG. 5, the control device 30 includes a power source section 31, a sensor driving section 32, a control section 33, a storage section 34, and a communication section 35. The control device 30 is configured such that the sensor driving section 32 receives electric signals each indicative of the value (measured value) of a weight that a weight scale 40 has measured.

The power source section 31 supplies electric power to each section of the control device 30, namely, the sensor driving section 32, the control section 33, the storage section 34, and the communication section 35. The power source section 31 may be, for example, a battery.

The sensor driving section 32 supplies electric power to the weight scale 40 for operation of the weight scale 40. The sensor driving section 32 also receives data on measured values from the weight scale 40. The sensor driving section 32, when having detected that a pet such as a cat has stepped onto the pet toilet 1, causes the weight scale 40 to make a measurement. The sensor driving section 32 outputs, to the control section 33, information indicative of the measured values that the sensor driving section 32 has received.

The control section 33 calculates the weight of urine that a pet such as a cat has discharged. The present embodiment is configured as an example such that the measured values from the weight scale 40 indicate the combined weight of (i) the absorbing sheet 18 containing urine and (ii) the excretion receiving container 16. The control section 33 thus subtracts the value of the combined weight of the absorbing sheet 18 not containing urine and the excretion receiving container 16 from the value of the combined weight (indicated by the measured values received) of the absorbing sheet 18 containing urine and the excretion receiving container 16 to calculate the amount of urine that the absorbing sheet 18 has absorbed. The value of the combined weight of the absorbing sheet 18 not containing urine and the excretion receiving container 16 is stored in the storage section 34 in advance. This stored value of the combined weight may be the value of a weight that the weight scale 40 measured immediately after an old absorbing sheet 18 was replaced with a new one.

The control section 33 then stores, in the storage section 34, data on the measured time point of the urination and the measured weight of the urine. The control section 33 may transmit the data (stored in the storage section 34) from the communication section 35 to a terminal device of the owner of the pet. This configuration allows the owner of the pet to check the stored data on the time point (number) of the urination and the weight of the urine to learn the health condition of the pet.

As illustrated in FIGS. 1, 3, and 4, the pet toilet 1 includes at least a support table 20, an excretion receiving container 16, and a weight scale 40. The support table 20 includes a bottom part 21 having a mesh 22 through which an excretion of an animal can pass. The excretion receiving container 16 is capable of being inserted in the main container 13. The excretion receiving container 16 as inserted faces the mesh 22 and receives an excretion having passed through the mesh 22. The weight scale 40 is present opposite to the support table 20 across the excretion receiving container 16 as inserted. The weight scale 40 weighs an excretion received by the excretion receiving container 16.

With the above configuration, the excretion receiving container 16 as inserted faces the mesh 22 of the support table 20 and is capable of receiving an excretion having passed through the mesh 22 of the support table 20.

The weight scale 40 includes (i) a table 42 configured to be pressed by the excretion receiving container 16 as inserted and (ii) weight sensors 41 each configured to output an electric signal indicative of the value of a measured weight which value corresponds to a pressing force from the table 42. This configuration allows the weight scale 40 to weigh an excretion received by the excretion receiving container 16.

The excretion receiving container 16 is detachable, so it can be detached from the main container 13 for removal of a received excretion and cleaning. The excretion receiving container 16 is thus easy to keep clean. This allows the pet toilet 1 to have high convenience.

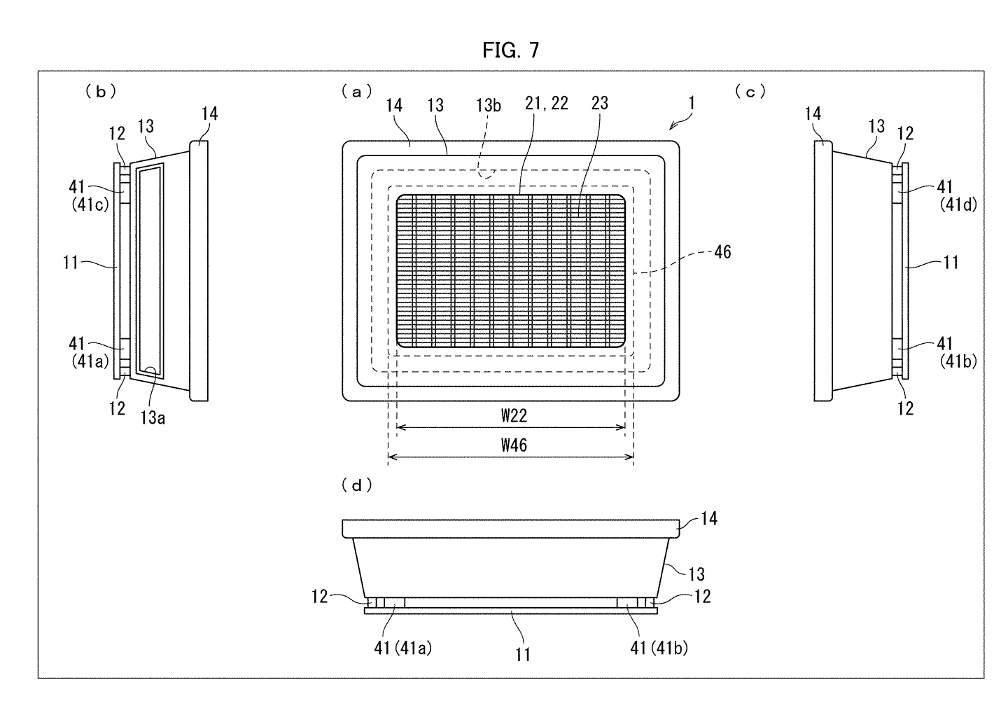

FIG. 6 is a cross-sectional view of a pet toilet 100 in accordance with a comparative example, illustrating the configuration of the pet toilet 100. The pet toilet 100 includes a weight scale 140 instead of the weight scale 40 of the pet toilet 1. The weight scale 140 differs from the weight scale 40 in that the weight scale 140 includes a protruding section 44 with no depressed portion 46 and has an upper surface (that is, the surface to be in contact with the back surface of an excretion receiving container 16) that is entirely flat. The weight scale 140 is, in other words, configured such that the protruding section 44 has a top surface 45 that is entirely flat.

With the configuration of the pet toilet 100, in a case where, for instance, a pet animal uses the pet toilet 100 with the excretion receiving container 16 detached therefrom as a result of, for example, the owner having forgot to insert the excretion receiving container 16, an excretion passes through the mesh 22 and falls directly onto the top surface 45 (upper surface) of the protruding section 44. Since the top surface 45 (upper surface) of the protruding section 44 is entirely flat, in a case where the excretion is urine (liquid), the urine runs along the upper surface and side surface of the protruding section 44 to finally drop downward from the table 42.

Thus, with the configuration of the pet toilet 100, in a case where a pet animal uses the pet toilet 100 with the excretion receiving container 16 detached therefrom, the weight scale 140 cannot weigh an excretion. In addition, an excretion that has dropped downward from the table 42 may leak out from the pet toilet 100.

On the other hand, the pet toilet 1 is configured as illustrated in FIGS. 1, 3, and 4 such that the table 42 has a depressed portion 46 that coincides with the mesh 22 across the excretion receiving container 16 as inserted. Thus, even with the excretion receiving container 16 detached from the main container 13, the depressed portion 46 can receive an excretion that has passed through the mesh 22 of the support table 20. Thus, even in a case where, for instance, a pet animal uses the pet toilet with the excretion receiving container 16 detached therefrom as a result of, for example, the owner having forgot to insert the excretion receiving container 16, the weight scale 40 can weigh an excretion. In addition, even with the excretion receiving container 16 detached from the main container 13, the pet toilet 1 can prevent an excretion from leaking out.

The table 42 includes a plate-shaped section 43 and a protruding section 44 protruding from the first surface 43a of the plate-shaped section 43. The protruding section 44 has a depressed portion 46 on the top surface 45. The depressed portion 46 is thus surrounded by a wall along the entire periphery. This allows the depressed portion 46 to receive a larger amount of excretion, with the result of increased convenience.

As illustrated in FIGS. 2 and 3, the present embodiment is configured such that the depressed portion 46 has an area not larger than the area of the region in which the mesh 22 is present. A small weight scale 40 is easy to handle. This allows an excretion received by the depressed portion 46 to be removed easily, making it easy to maintain the weight scale 40.

The present embodiment is configured such that the depressed portion 46 and the mesh 22 are each present in a region whose longitudinal direction is parallel to the direction in which the excretion tray 19 is slid to be inserted. In FIGS. 2 and 3, W22>W46, where W46 represents the length (longitudinal dimension) of the region of the depressed portion 46, and W22 represents the length of the region of the mesh 22. The two lengths W22 and W46 may be equal to each other. The present embodiment may be further configured such that the region of the depressed portion 46 has a width (that is, the dimension orthogonal to the length) not larger than the width of the region of the mesh 22.

As illustrated in FIG. 1, FIG. 3, and (a) of FIG. 4, the depressed portion 46 may have a side surface 47 inclined such that the depressed portion 46 becomes wider toward the mesh 22. This configuration allows an excretion received by the depressed portion 46 to be removed easily, making it easy to maintain the weight scale 40.

### Embodiment 2

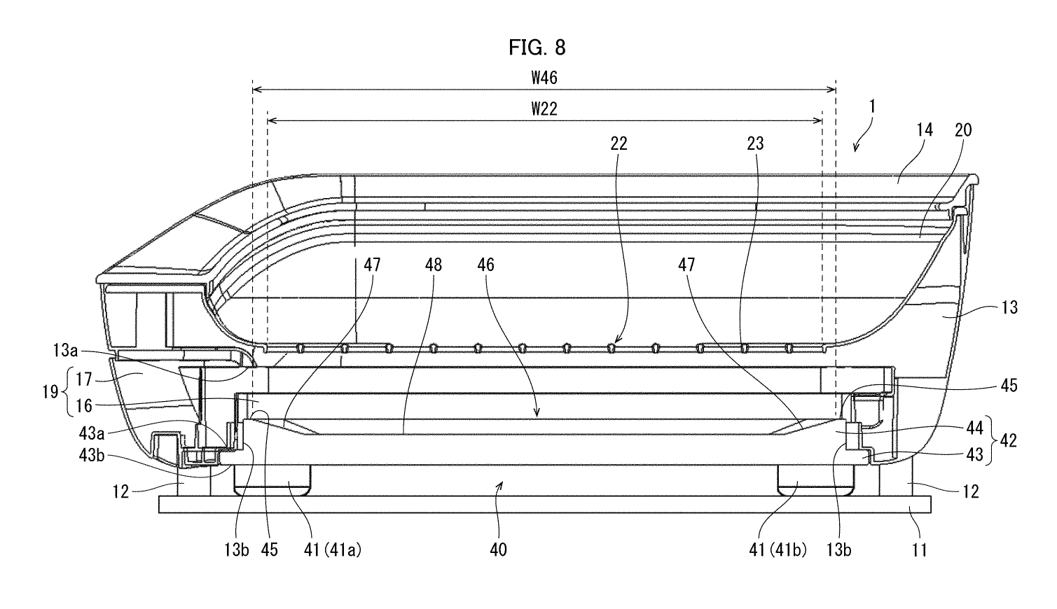

(a) of FIG. 7 is a plan view of a pet toilet 1 in accordance with Embodiment 2, illustrating the overall configuration of the pet toilet 1. (b) of FIG. 7 is a left side view of the pet toilet 1 illustrated in (a) of FIG. 7, illustrating the overall configuration of the pet toilet 1. (c) of FIG. 7 is a right side view of the pet toilet 1 illustrated in (a) of FIG. 7, illustrating the overall configuration of the pet toilet 1. (d) of FIG. 7 is a front side view of the pet toilet 1 illustrated in (a) of FIG. 7, illustrating the overall configuration of the pet toilet 1. FIG. 8 is a cross-sectional view of the pet toilet 1 in accordance with Embodiment 2, illustrating the configuration of the pet toilet 1.

As illustrated in FIGS. 7 and 8, the pet toilet 1 may be configured such that the depressed portion 46 has an area larger than the area of the mesh 22. This configuration allows the depressed portion 46 to more reliably receive an excretion having passed through the mesh 22. With the above configuration, even in a case where a pet animal uses the pet toilet 1 with the excretion receiving container 16 detached from the main container 13, the weight scale 40 can more accurately weigh an excretion, and the pet toilet 1 can more effectively prevent an excretion from leaking out.

In FIGS. 7 and 8, W46>W22, where W46 represents the length (longitudinal dimension) of the region of the depressed portion 46, and W22 represents the length of the region of the mesh 22. The present embodiment may be further configured such that the region of the depressed portion 46 has a width larger than the width of the region of the mesh 22.

### Embodiment 3

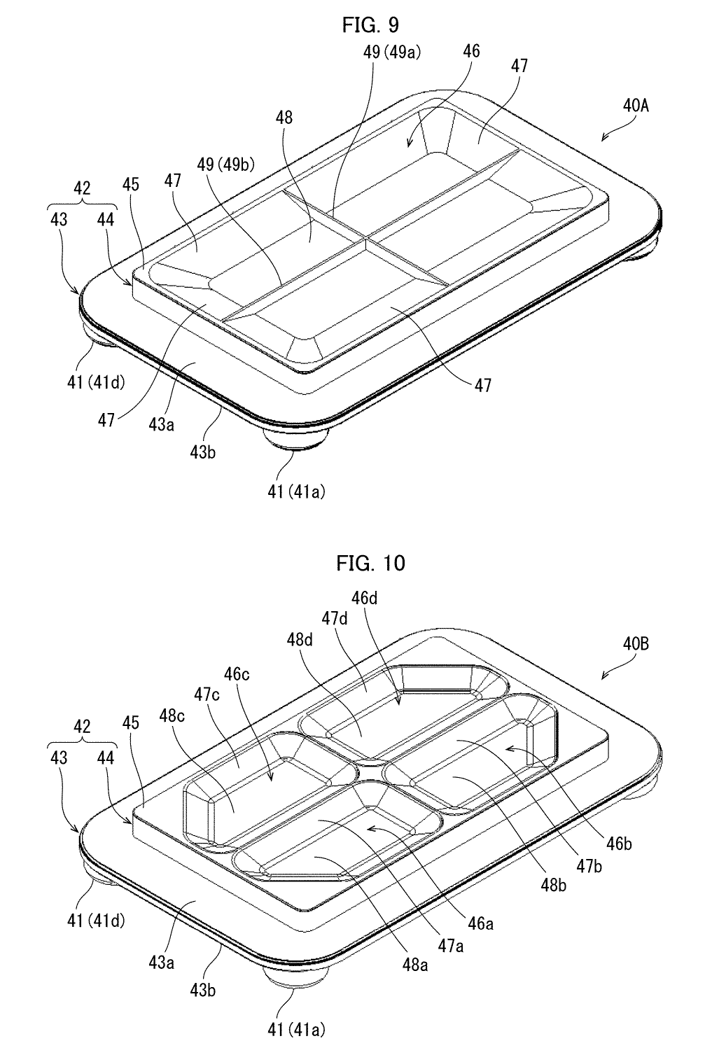

FIG. 9 is a perspective view of a weight scale 40A included in a pet toilet 1 in accordance with Embodiment 3. A pet toilet 1 may include, instead of the weight scale 40 (see FIGS. 1, 3, and 4), the weight scale 40A illustrated in FIG. 9. The weight scale 40A includes ribs 49 in the depressed portion 46. The weight scale 40A is otherwise similar in configuration to the weight scale 40.

FIG. 9 illustrates two ribs 49, namely ribs 49a and 49b. The ribs 49a and 49b extend along the bottom surface of the depressed portion 46 in respective directions different from each other and cross each other. The ribs 49a and 49b each have opposite ends that are jointed with respective portions of the side surface 47 of the depressed portion 46 which portions face each other. The space inside the depressed portion 46 may consequently be divided by the ribs 49a and 49b into a plurality of regions (in FIG. 9, four regions).

With the above configuration, the ribs 49a and 49b allow the table 42 to be more rigid. This can prevent the table 42 from deforming due to, for example, degradation over time. Further, sliding the excretion receiving container 16 (see FIGS. 1 and 3) into the main container 13 causes the back surface of the excretion receiving container 16 to slide along the respective top surfaces of the ribs 49a and 49b while in contact with the respective top surfaces of the ribs 49a and 49b as well. Thus, when the excretion receiving container 16 is slid into the main container 13, the ribs 49a and 49b guide the excretion receiving container 16, thereby facilitating the insertion.

FIG. 9 illustrates the ribs 49a and 49b as being orthogonal to each other. The ribs 49a and 49b are, however, not necessarily orthogonal to each other. The ribs 49a and 49b may cross each other in any manner that divides the space inside the depressed portion 46 into a plurality of regions.

The number of ribs provided in the depressed portion 46 is not limited to two. The space inside the depressed portion 46 may be divided into a plurality of regions by a single rib or three or more ribs.

### Embodiment 4

FIG. 10 is a perspective view of a weight scale 40B included in a pet toilet 1 in accordance with Embodiment 4. A pet toilet 1 may include, instead of the weight scale 40 (see FIGS. 1, 3, and 4), the weight scale 40B illustrated in FIG. 10. The weight scale 40B includes a protruding section 44 having a plurality of depressed portions 46a, 46b, 46c, and 46d. The weight scale 40B is otherwise similar in configuration to the weight scale 40.

The protruding section 44 of the weight scale 40B has a top surface 45 with depressed portions 46a, 46b, 46c, and 46d arranged apart from one another. With the above configuration, the walls between the depressed portions 46a, 46b, 46c, and 46d allow the table 42 to be more rigid. This can prevent the table 42 from deforming due to, for example, degradation over time. In addition, when the excretion receiving container 16 (see FIGS. 1 and 3) is slid into the main container 13, the walls between the depressed portions 46a, 46b, 46c, and 46d guide the excretion receiving container 16, thereby facilitating the insertion.

The depressed portion 46a has a side surface 47a inclined such that the depressed portion 46a becomes wider toward the mesh 22 (see FIGS. 1 and 3). The depressed portion 46b has a side surface 47b inclined such that the depressed portion 46b becomes wider toward the mesh 22 (see FIGS. 1 and 3). The depressed portion 46c has a side surface 47c inclined such that the depressed portion 46c becomes wider toward the mesh 22 (see FIGS. 1 and 3). The depressed portion 46d has a side surface 47d inclined such that the depressed portion 46d becomes wider toward the mesh 22 (see FIGS. 1 and 3). This allows an excretion received by the depressed portions 46a, 46b, 46c, and 46d to be removed easily, making it easy to maintain the weight scale 40B.

FIG. 10 illustrates the depressed portions 46a, 46b, 46c, and 46d as having respective bottom surfaces 48a, 48b, 48c, and 48d that are flat. The bottom surfaces 48a, 48b, 48c, and 48d are, however, not necessarily flat.

Not all of the respective side surfaces of the depressed portions 46a, 46b, 46c, and 46d are necessarily inclined. One, two, or three of the side surfaces may each be perpendicular to the bottom surface. The number of depressed portions in the protruding section 44 is not limited to four, and may be two, three, or five or more.

### Embodiment 5

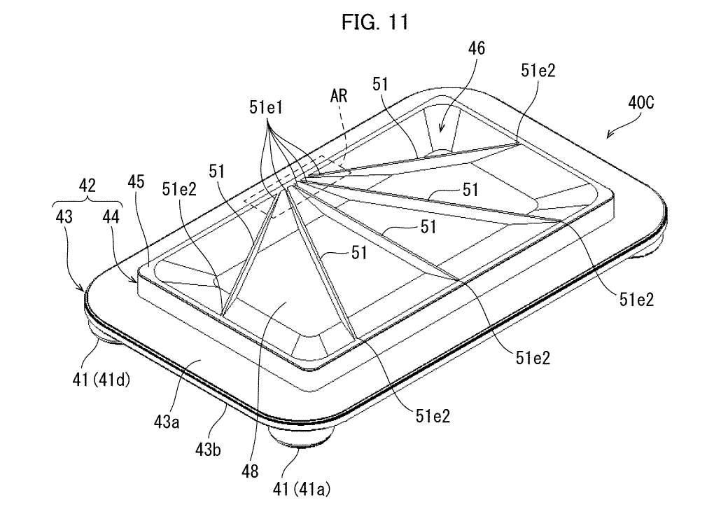

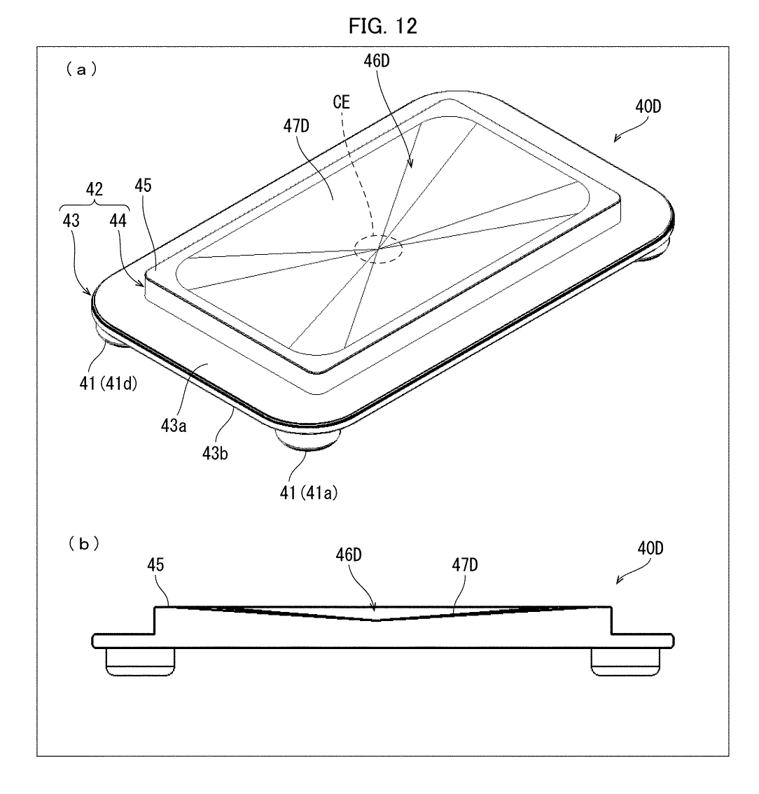

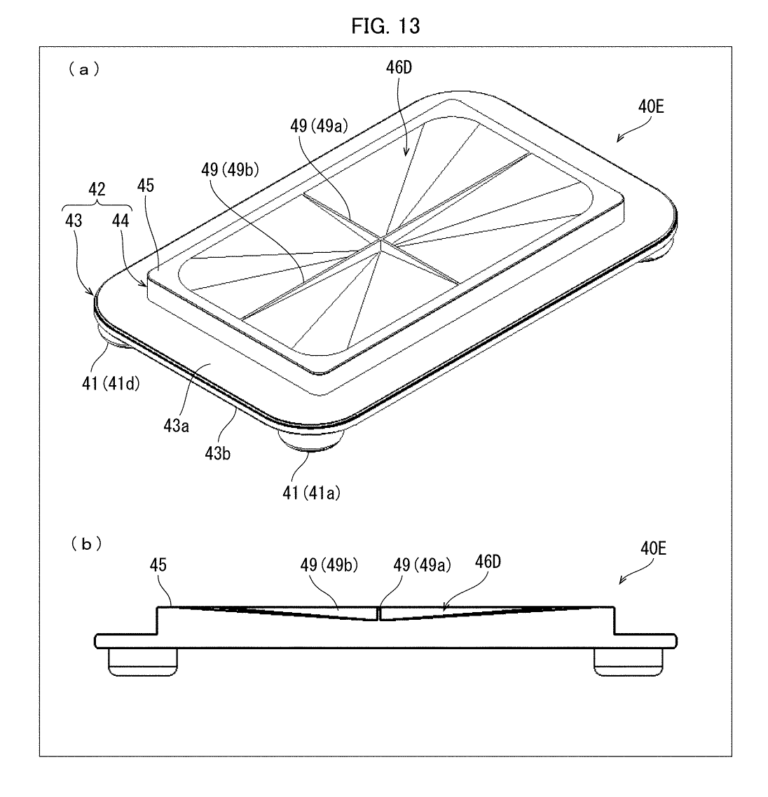

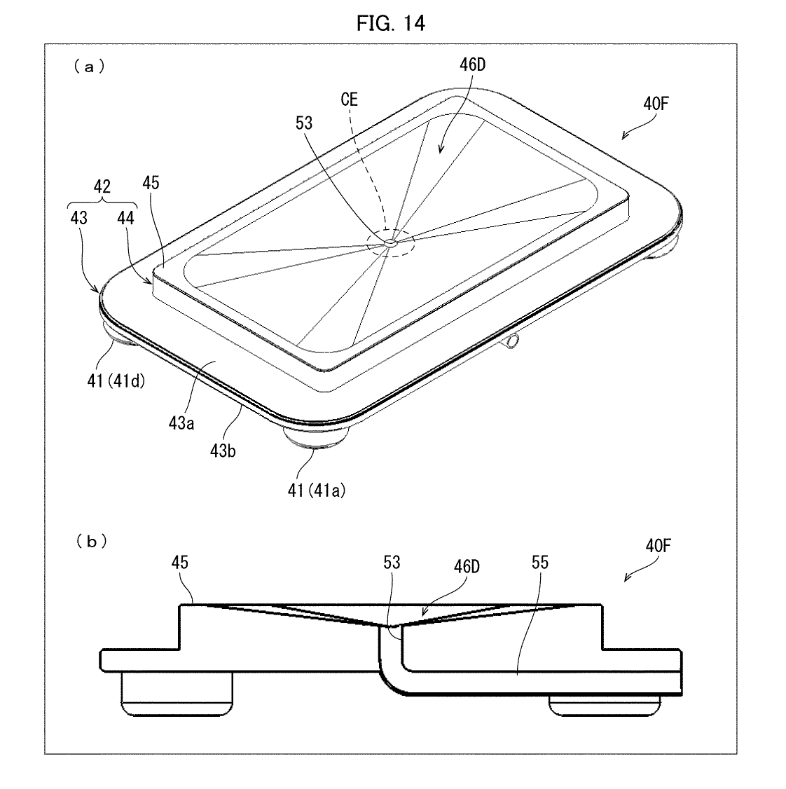

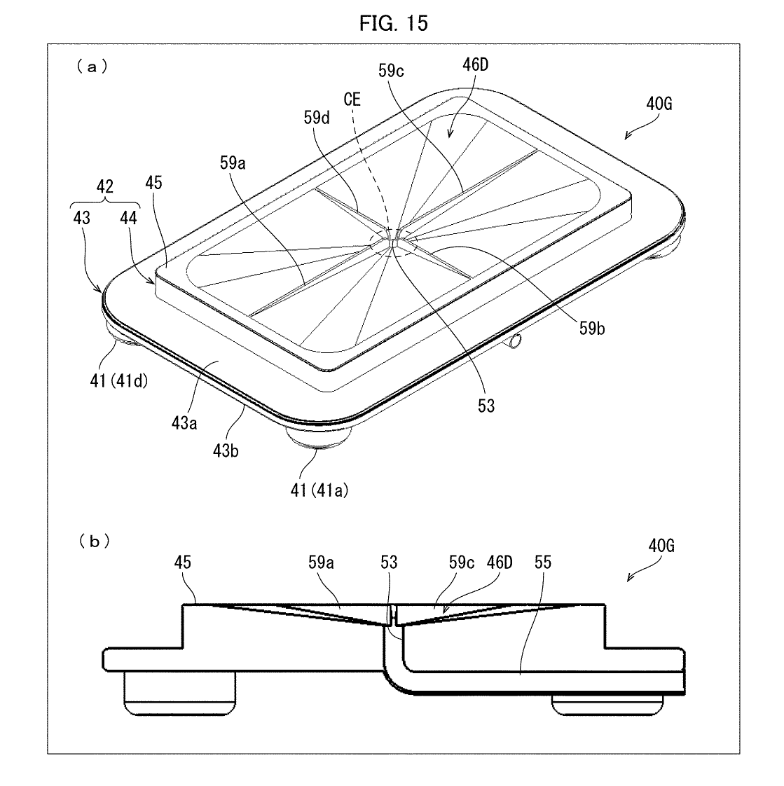

FIG. 11 is a perspective view of a weight scale 40C included in a pet toilet 1 in accordance with Embodiment 5. A pet toilet 1 may include, instead of the weight scale 40 (see FIGS. 1, 3, and 4), the weight scale 40C illustrated in FIG. 11. The weight scale 40C includes a plurality of ribs 51 in the depressed portion 46. The weight scale 40C is otherwise similar in configuration to the weight scale 40.

The weight scale 40C illustrated in FIG. 11 includes in the depressed portion 46 a plurality of ribs 51 that extend in respective directions different from one another and that do not cross one another. The ribs 51 extend along the bottom surface 48 of the depressed portion 46.

The ribs 51 each have an end 51e1 and another end 51e2. The respective ends 51e1 of the ribs 51 are separated from one another by a first distance, whereas the respective ends 51e2 of the ribs 51 are separated from one another by a second distance larger than the first distance.

With the above configuration, removing the weight scale 40C from the main container 13 and inclining the table 42 so that the ends 51e1 are below the ends 51e2 causes an excretion in the depressed portion 46 to be collected along the ribs 51 into a region in the vicinity of the ends 51e1 (that is, the region AR illustrated in FIG. 11). This allows an excretion in the depressed portion 46 to be easily collected for removal, making it easy to maintain the weight scale 40C.

FIG. 11 illustrates the space inside the depressed portion 46 as being divided by the five ribs 51 into six regions. The number of ribs 51 is, however, not limited to five, and is any number of two or more.

### Embodiment 6

(a) of FIG. 12 is a perspective view of a weight scale 40D included in a pet toilet 1 in accordance with Embodiment 6. (b) of FIG. 12 is a cross-sectional view of the weight scale 40D illustrated in (a) of FIG. 12. A pet toilet 1 may include, instead of the weight scale 40 (see FIGS. 1, 3, and 4), the weight scale 40D illustrated in FIG. 12. The weight scale 40D differs from the weight scale 40 on the shape of the depressed portion 46. The weight scale 40D is otherwise similar in configuration to the weight scale 40.

The weight scale 40D may include a protruding section 44 having a depressed portion 46D with a side surface 47D inclined such that the depressed portion 46D is narrower at a substantially central portion of the depressed portion 46D and wider at the top surface 45 (edge) of the protruding section 44. With this configuration, the depressed portion 46D is deepest at a substantially central portion, thereby causing an excretion to be collected at the substantially central portion of the depressed portion 46D. This allows the weight scale to weight an excretion more accurately.

The substantially central portion of the depressed portion 46D refers to a region that covers the center of the depressed portion 46D and that is in the vicinity of the center (that is, the region CE).

The side surface 47D may be inclined such that the depressed portion 46D is narrower at a predetermined position in the depressed portion 46D other than the substantially central portion and wider at the top surface 45 (edge) of the protruding section 44. With this configuration, the depressed portion 46D is deepest at the predetermined position, thereby causing an excretion to be collected at the predetermined position in the depressed portion 46D. This also advantageously reduces the risk of an excretion being present at a random position in the depressed portion 46D, thereby allowing the weight scale 40D to weight an excretion more accurately.

In a case where weight sensors 41a, 41b, 41c, and 41d are each attached to one of the four corners of the second surface 43b of the plate-shaped section 43 as illustrated in (b) of FIG. 4, collecting an excretion at the substantially central portion of the depressed portion 46D allows the weight scale 40D to weight an excretion more accurately.

### Embodiment 7

(a) of FIG. 13 is a perspective view of a weight scale 40E included in a pet toilet 1 in accordance with Embodiment 7. (b) of FIG. 13 is a cross-sectional view of the weight scale 40E illustrated in (a) of FIG. 13. A pet toilet 1 may include, instead of the weight scale 40D (see FIG. 12), the weight scale 40E illustrated in FIG. 13. The weight scale 40E includes a plurality of ribs 49 in the depressed portion 46D.

FIG. 13 illustrates two ribs 49, namely ribs 49a and 49b. The ribs 49a and 49b extend in the depressed portion 46 in respective directions different from each other and cross each other. The ribs 49a and 49b each have opposite ends that are joined with respective portions of the edge (that is, respective sides) of the depressed portion 46D which portions face each other. The space inside the depressed portion 46D may consequently be divided by the ribs 49a and 49b into a plurality of regions (in FIG. 13, four regions).

The above configuration causes an excretion to be collected at a substantially central portion of the depressed portion 46D (or at a predetermined position in the depressed portion 46D). Further, the ribs 49a and 49b allow the table 42 to be more rigid. This can prevent the table 42 from deforming due to, for example, degradation over time. Further, sliding the excretion receiving container 16 (see FIGS. 1 and 3) into the main container 13 causes the back surface of the excretion receiving container 16 to slide along the respective top surfaces of the ribs 49a and 49b while in contact with the respective top surfaces of the ribs 49a and 49b as well. Thus, when the excretion receiving container 16 is slid into the main container 13, the ribs 49a and 49b guide the excretion receiving container 16, thereby facilitating the insertion.

### Embodiment 8

(a) of FIG. 14 is a perspective view of a weight scale 40F included in a pet toilet 1 in accordance with Embodiment 8. (b) of FIG. 14 is a cross-sectional view of the weight scale 40F illustrated in (a) of FIG. 14. A pet toilet 1 may include, instead of the weight scale 40D (see FIG. 12), the weight scale 40F illustrated in FIG. 14. The weight scale 40F includes a table 42 having a through hole at a substantially central portion of the depressed portion 46D, and also includes a pipe 55. The weight scale 40F is otherwise similar in configuration to the weight scale 40D.

The pipe 55 has an end connected to the through hole 53 inside the protruding section 44, and extends from inside the protruding section 44 along the back surface of the table 42. The pipe 55 has another end that is open.

The weight scale 40F is capable of causing an excretion received by the depressed portion 46D to run through the through hole 53 and the pipe 55 to outside the depressed portion 46D for removal, making it easy to maintain the weight scale 40F. The pipe 55 may extend not on the back surface of the table 42 but off the back surface.

The position of the through hole 53 is not limited to the substantially central portion of the depressed portion 46D, and may be a predetermined position in the depressed portion 46D which predetermined position is other than the substantially central portion. This also makes it possible to cause an excretion received by the depressed portion 46D to run through the through hole 53 and the pipe 55 to outside the depressed portion 46D for removal. However, a through hole 53 at a substantially central portion of the depressed portion 46D makes it possible to more efficiently cause an excretion received by the depressed portion 46D to run through the through hole 53 and the pipe 55 to outside the depressed portion 46D for removal.

The through hole 53 is plugged during normal use in order for urine to be kept in the depressed portion 46D. This makes it possible to weigh the urine. For cleaning, the through hole 53 is unplugged in order for the urine in the depressed portion 46D to run to outside for removal.

### Embodiment 9

(a) of FIG. 15 is a perspective view of a weight scale 40G included in a pet toilet 1 in accordance with Embodiment 9. (b) of FIG. 15 is a cross-sectional view of the weight scale 40G illustrated in (a) of FIG. 15. A pet toilet 1 may include, instead of the weight scale 40F (see FIG. 14), the weight scale 40G illustrated in FIG. 15.

The weight scale 40G is configured as with the weight scale 40F, and includes a plurality of ribs 59a, 59b, 59c, and 59d in the depressed portion 46D. The weight scale 40G is otherwise similar in configuration to the weight scale 40F.

The ribs 59a, 59b, 59c, and 59d each have (i) an end at a through hole 53 in a substantially central portion of the depressed portion 46D (or at a predetermined position in the depressed portion 46D) and (ii) another end joined with one of the four sides constituting the edge of the depressed portion 46D. The ribs 59a, 59b, 59c, and 59d extend from the through hole 53 as the center in respective directions that cross one another. The ribs 59a, 59b, 59c, and 59d, in other words, extend radially from the through hole 53 as the center.

The space inside the depressed portion 46D is consequently divided by the ribs 59a, 59b, 59c, and 59d into a plurality of regions (in FIG. 15, four regions).

The above configuration makes it possible to cause an excretion received by the depressed portion 46D to run through the through hole 53 and the pipe 55 to outside the depressed portion 46D for removal. In addition, the ribs 59a, 59b, 59c, and 59d allow the table 42 to be more rigid. This can prevent the table 42 from deforming due to, for example, degradation over time. Further, sliding the excretion receiving container 16 (see FIGS. 1 and 3) into the main container 13 causes the back surface of the excretion receiving container 16 to slide along the respective top surfaces of the ribs 59a, 59b, 59c, and 59d while in contact with the respective top surfaces of the ribs 59a, 59b, 59c, and 59d as well. Thus, when the excretion receiving container 16 is slid into the main container 13, the ribs 59a, 59b, 59c, and 59d guide the excretion receiving container 16, thereby facilitating the insertion.

Embodiment 9 is similar to Embodiment 8 as follows: The through hole 53 is plugged during normal use in order for urine to be kept in the depressed portion 46D. This makes it possible to weigh the urine. For cleaning, the through hole 53 is unplugged in order for the urine in the depressed portion 46D to run to outside for removal.

The embodiments described above are each configured to weigh only an excretion, but may each be configured to weigh the pet simultaneously. In that case, the embodiments above are each configured such that the vertical poles 12 supporting the main container 13 are replaced with weight sensors. This configuration allows the weight sensors to, when the pet has stepped onto the support table, measure a weight increase as the weight of the pet.

### Recap

An animal toilet (pet toilet 1) in accordance with a first aspect of the present invention includes: a support table having a bottom surface having an opening through which an excretion of an animal passes; an excretion receiving container, the excretion receiving container being detachable and configured to (i) face the opening when attached and (ii) receive the excretion having passed through the opening; and a weight scale present opposite to the support table across the excretion receiving container as attached, the weight scale being configured to weigh the excretion received by the excretion receiving container, the weight scale including (i) a table configured to be pressed by the excretion receiving container as attached and (ii) a weight sensor configured to output an electric signal indicative of a value of a measured weight which value corresponds to a pressing force from the table included in the weight scale, the table included in the weight scale having at least one depressed portion that coincides with the opening across the excretion receiving container as attached.

With the above configuration, the excretion receiving container as attached faces the opening of the support table and is thus capable of receiving an excretion that passes through the opening of the support table.

The weight scale includes (i) a table configured to apply an upward pressing force to the excretion receiving container as attached and (ii) a weight sensor configured to output an electric signal indicative of the value of a measured weight which value corresponds to a pressing force from the table. This configuration allows the weight scale to weigh an excretion received by the excretion receiving container.

The excretion receiving container is detachable, so it can be detached from the animal toilet for removal of an excretion received. As described above, the animal toilet allows the excretion receiving container to be kept clean easily, and has high convenience.

The table included in the weight scale has at least one depressed portion that coincides with the opening across the excretion receiving container as attached. With this configuration, the depressed portion is capable of, even with the excretion receiving container detached, receiving an excretion having passed through the opening of the support table. Thus, even in a case where, for instance, the excretion receiving container is detached as a result of, for example, the pet owner having forgot to attach the excretion receiving container, the weight scale can weigh an excretion. In addition, even with the excretion receiving container detached, the animal toilet can prevent an excretion from leaking out. This prevents an excretion from dirtying the area surrounding the animal toilet.

An animal toilet in accordance with a second aspect of the present invention is configured as in the first aspect, and may be further configured such that the table included in the weight scale includes (i) a plate-shaped member and (ii) a protruding section protruding from a surface of the plate-shaped member which surface is on a side of the excretion receiving container as attached, and the at least one depressed portion is present on a top surface of the protruding section. This configuration allows the depressed portion to receive a larger amount of excretion, with the result of increased convenience.

An animal toilet in accordance with a third aspect of the present invention is configured as in the first or second aspect, and may be further configured such that the at least one depressed portion has an area not larger than an area of the opening. With this configuration, the weight scale can be small and is thus easy to handle. This allows an excretion received by the depressed portion to be removed easily, making it easy to maintain the weight scale.

An animal toilet in accordance with a fourth aspect of the present invention is configured as in the first or second aspect, and may be further configured such that the at least one depressed portion has an area larger than an area of the opening. This configuration allows the depressed portion to more reliably receive an excretion having passed through the opening.

An animal toilet in accordance with a fifth aspect of the present invention is configured as in any one of the first to fourth aspects, and may be further configured such that the at least one depressed portion has a side surface inclined such that the at least one depressed portion becomes wider toward the opening. This configuration allows an excretion received by the depressed portion to be removed easily, making it easy to maintain the weight scale.

An animal toilet in accordance with a sixth aspect of the present invention is configured as in any one of the first to fifth aspects, and may be further configured such that the at least one depressed portion is provided with one or more ribs, and the one or more ribs divide a space inside the at least one depressed portion into a plurality of regions.

With the above configuration, the one or more ribs allow the table to be more rigid. This can prevent the table from deforming due to, for example, degradation over time. In addition, when the excretion receiving container is attached, the one or more ribs guide the excretion receiving container, thereby facilitating the attachment.

An animal toilet in accordance with a seventh aspect of the present invention is configured as in any one of the first to sixth aspects, and may be further configured such that the at least one depression includes an array of a plurality of depressions, and each of the plurality of depressed portions has a side surface inclined such that said each of the plurality of depressed portions becomes wider toward the opening.

With the above configuration, the walls between the plurality of depressed portions allow the table to be more rigid. This can prevent the table from deforming due to, for example, degradation over time. In addition, when the excretion receiving container is attached, the walls between the plurality of depressed portions guide the excretion receiving container, thereby facilitating the attachment. Further, the plurality of depressed portions each have a side surface inclined such that the depressed portion becomes wider toward the opening. This allows an excretion received by the depressed portion to be removed easily, making it easy to maintain the weight scale.

An animal toilet in accordance with an eighth aspect of the present invention is configured as in any one of the first to fifth aspects, and may be further configured such that the at least one depressed portion is provided with a plurality of ribs that extend in respective directions different from each other and that do not cross each other, and the plurality of ribs have respective first ends and respective second ends, the first ends being separated from each other by a first distance, the second ends being separated from each other by a second distance larger than the first distance. With this configuration, inclining the table so that the respective first ends of the plurality of ribs are below the respective second ends of the plurality of ribs causes an excretion in the depressed portion to be collected along the plurality of ribs into a region in the vicinity of the first ends. This allows an excretion in the depressed portion to be easily collected for removal, making it easy to maintain the weight scale.

An animal toilet in accordance with a ninth aspect of the present invention is configured as in any one of the first to eighth aspects, and may be further configured such that the at least one depressed portion has a side surface inclined such that the at least one depressed portion is narrower at a predetermined position in the at least one depressed portion and wider at an edge of the at least one depressed portion. This configuration allows an excretion to be collected not at a random position but at a predetermined position in the depressed portion. This allows the weight scale to weight an excretion more accurately.

An animal toilet in accordance with a tenth aspect of the present invention is configured as in any one of the first to ninth aspects, and may be further configured such that the table included in the weight scale has a through hole at a predetermined position in the depressed portion, and the weight scale further includes a pipe having a first end connected to the through hole and a second end that is open. This configuration causes an excretion received by the depressed portion to run through the through hole and the pipe to outside the depressed portion for removal, making it easy to maintain the weight scale.

An animal toilet in accordance with an eleventh aspect of the present invention is configured as in the ninth or tenth aspect, and is preferably further configured such that the predetermined position is substantially a center of the depressed portion. This configuration allows an excretion to be collected substantially at the center of the depressed portion, and thus allows an excretion to be collected not at a random position but at a predetermined position in the depressed portion. This allows the weight scale to weight an excretion more accurately. Further, with the above configuration, a through hole substantially at the center of the depressed portion makes it possible to more efficiently cause an excretion received by the depressed portion to run through the through hole and the pipe to outside the depressed portion for removal.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Pet toilet (animal toilet)
13 Main container
13a Side opening
13b Weight scale through hole
16 Excretion receiving container
17 Slidable frame
18 Absorbing sheet
19 Excretion tray
20 Support table
22 Mesh
23 Slit (opening)
30 Control device
40, 40A to 40G Weight scale
41, 41a to 41d Weight sensor
43 Plate-shaped section (plate-shaped member)
44 Protruding section
45 Top surface
46, 46a to 46d, 46D Depressed portion
47, 47a to 47d, 47D Side surface
48, 48a to 48d Bottom surface
49, 49a, 49b, 51, 59a to 59d Rib
53 Through hole
55 Pipe

1. An animal toilet, comprising:
a support table having a bottom surface having an opening through which an excretion of an animal passes;
an excretion receiving container, the excretion receiving container being detachable and configured to (i) face the opening when attached and (ii) receive the excretion having passed through the opening; and
a weight scale present opposite to the support table across the excretion receiving container as attached, the weight scale being configured to weigh the excretion received by the excretion receiving container,
the weight scale including (i) a table configured to be pressed by the excretion receiving container as attached and (ii) a weight sensor configured to output an electric signal indicative of a value of a measured weight which value corresponds to a pressing force from the table included in the weight scale,
the table included in the weight scale having at least one depressed portion that coincides with the opening across the excretion receiving container as attached.

2. The animal toilet according to claim 1, wherein
the table included in the weight scale includes (i) a plate-shaped member and (ii) a protruding section protruding from a surface of the plate-shaped member which surface is on a side of the excretion receiving container as attached, and
the at least one depressed portion is present on a top surface of the protruding section.

3. The animal toilet according to claim 1, wherein
the at least one depressed portion has an area not larger than an area of the opening.

4. The animal toilet according to claim 1, wherein
the at least one depressed portion has an area larger than an area of the opening.

5. The animal toilet according to claim 1, wherein
the at least one depressed portion has a side surface inclined such that the at least one depressed portion becomes wider toward the opening.

6. The animal toilet according to claim 1, wherein
the at least one depressed portion is provided with one or more ribs, and
the one or more ribs divide a space inside the at least one depressed portion into a plurality of regions.

7. The animal toilet according to claim 1, wherein
the at least one depressed portion includes an array of a plurality of depressed portions, and
each of the plurality of depressed portions has a side surface inclined such that said each of the plurality of depressed portions becomes wider toward the opening.

8. The animal toilet according to claim 1, wherein
the at least one depressed portion is provided with a plurality of ribs that extend in respective directions different from each other and that do not cross each other, and
the plurality of ribs have respective first ends and respective second ends, the first ends being separated from each other by a first distance, the second ends being separated from each other by a second distance larger than the first distance.

9. The animal toilet according to claim 1, wherein
the at least one depressed portion has a side surface inclined such that the at least one depressed portion is narrower at a predetermined position in the at least one depressed portion and wider at an edge of the at least one depressed portion.

10. The animal toilet according to claim 1, wherein
the table included in the weight scale has a through hole at a predetermined position in the depressed portion, and
the weight scale further includes a pipe having a first end connected to the through hole and a second end that is open.

11. The animal toilet according to claim 9, wherein
the predetermined position is substantially a center of the depressed portion.
